(19) United States
(12) Patent Application Publication
(10) Pub. No.: US 2025/0045140 A1
(43) Pub. Date: Feb. 6, 2025

(54) ALERT FILTERING BASED ON SERVICE TO FACILITATE TRIAGE

(71) Applicant: ServiceNow, Inc., Santa Clara, CA (US)

(72) Inventors: Rani Tzur, Tzur Yigal (IL); Shay Cohen, Ruhama (IL); Maia Golan, HaYogev (IL); Maayan Wigelman, Kfar Saba (IL)

(21) Appl. No.: 18/229,048

(22) Filed: Aug. 1, 2023

(51) Int. Cl. G06F 11/07; G06F 9/451

(52) U.S. Cl. CPC G06F 11/0781; G06F 9/451; G06F 11/0709

(57) ABSTRACT

In various embodiments, a process for alert filtering based on service to facilitate triage includes receiving an alert, identifying a configuration item of a computer information technology configuration management system associated with the alert, and identifying a property of the configuration item stored separately from one or more properties included in the alert. The process includes enabling filtering of the alert based on the property of the configuration item.

### BACKGROUND OF THE INVENTION

System administrators are responsible for monitoring the performance of computer networks. Alerts may be generated by various network components that report the status and operational state of the components. Administrators may monitor the performance and capability of computer systems to identify discrepancies (alerts), resolve alerts by troubleshooting the issues for efficient functioning of infrastructure, track and document defects/resolutions, and report incidents by escalating complicated issues. Currently, administrators spend a great deal of time and effort monitoring alerts and resolving incidents. Thus, there is a need to improve the presentation of alerts.

### BRIEF DESCRIPTION OF THE DRAWINGS

Various embodiments of the invention are disclosed in the following detailed description and the accompanying drawings.

FIG. 1 is a diagram illustrating an example of a graphical user interface for alert filtering based on service to facilitate triage.

FIG. 2 is a flow diagram illustrating an embodiment of a process for alert filtering based on service to facilitate triage.

FIG. 3 shows an example of a service map for which alert filtering based on service to facilitate triage may be performed.

FIG. 4A shows an example of a user interface for editing filter attributes.

FIG. 4B shows an example of a user interface for editing filter attributes to add tags to filters.

FIG. 5 shows an example of an alert panel.

FIG. 6 is a functional diagram illustrating a programmed computer system for executing alert filtering based on service to facilitate triage in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications, and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

In various embodiments, alerts are processed to identify an associated configuration item (CI) and property of the configuration item. Unlike conventional techniques, the disclosed techniques include dynamic filtering based on any attribute and/or calculation. For example, alerts may be filtered by tags, impacted services, or CIs. Alerts may be filtered based on the identified property of the configuration item. Alerts may be filtered by tags (key-value pairs), impacted services, CIs, or the like. Alerts may be grouped, and remediation actions performed to/for the group. An interactive filter panel allows alerts to be filtered dynamically and according to user preferences. The filter panel provides options to create different views without leaving the current workspace or graphical user interface. The filter panel changes the list view in response to user input of filtering criteria.

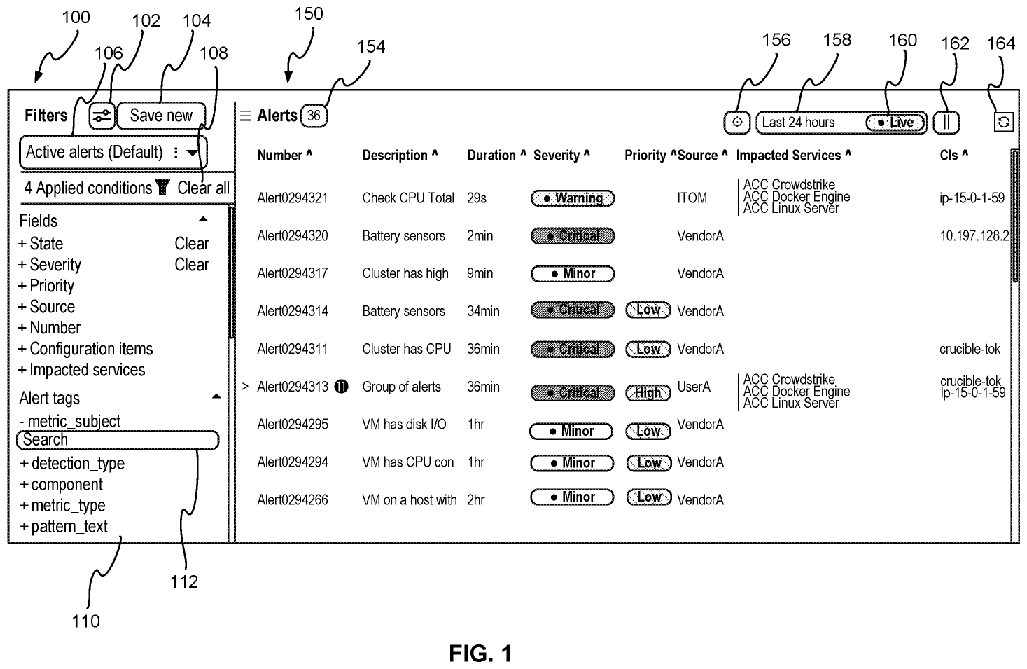

FIG. 1 is a diagram illustrating an example of a graphical user interface for alert filtering based on service to facilitate triage. This graphical user interface (GUI) is sometimes referred to as an “express list” or simply “list,” because it permits a user to efficiently triage incoming alerts. The disclosed techniques can be applied to various platforms such as a service operations workspace by ServiceNow®. This GUI shows an express list that can be displayed within a service operations workspace.

The list can be used to monitor systems and services, resolve alerts, find the root cause, realize the alert impact, track issues, and report incidents, among other things. Here, the list shows nine alerts (more can be displayed by scrolling down), beginning with Alert0294321. Each alert is displayed in a respective row. An icon 154 indicates the total number of alerts in the express list.

This graphical user interface shows an express list, which can be used by users (sometimes called “administrators”) for information technology (IT) operations, e.g., to monitor the infrastructure, applications, and services of or provided by an organization. Typically, users perform their tasks by monitoring alerts, examples of which are shown here. A user may review the alerts and prioritize them to ensure that operations are normal, e.g., services are up and running and there is no degradation in performance and the availability of the services. In this example, alerts are displayed in a list. As further described herein, the list may be a live view, reflecting real-time updates. When a new alert is created or updated, the list is refreshed automatically without requiring any intervention of the user.

The alerts may be generated by various monitoring systems or anomaly engines. Alerts may be continuously created depending on the size of the network and condition. For example, on the order of thousands of alerts may be created each day.

The express list is helpful for reviewing an alert and provides an easy-to-understand list of alerts in a list area 150. In various embodiments, the list provides a live view of the current alerts and can be refreshed at a user-defined rate. For example, status 160 indicates that the list is currently a live view. A user may select a date and time range 158 to view the alerts. The time range may include one or more options such as all time, last week, last 24 hours, last 12 hours, last hour, last 15 minutes. These example time ranges are merely exemplary and not intended to be limiting as other time ranges are possible. A user may define a custom range such as selecting a date period from a calendar.

A user may pause and resume the live updates by selecting the pause button 162 or resume button 164. A user can pause and resume the automatic updates on this list. When a list is paused, the list can be updated with alerts, without refreshing the current view of alerts when the live updates are paused. This can be especially beneficial when there is a high volume of alerts, because being able to pause the updates allows a user to review a set of alerts without being inundated with new alerts.

An interactive filter panel 100 provides options to create different views without leaving the current workspace or graphical user interface. The filter panel changes the list view in response to user input of various options such as 106 and 108. In various embodiments, the express list is presented with filtering functionality. This enables a user to dynamically apply various filter criteria to look at the alerts and information associated with alerts. For example, a user who wishes to review only urgent (critical severity) alerts can apply a filter so that only alerts that meet this criterion are displayed in the express list.

In various embodiments, selecting the filter (funnel) icon next to “Applied conditions” causes the applied conditions to be displayed. For example, the applied conditions may be displayed as a pop-up window (not shown). In this example in which there are four applied conditions, the conditions include: Acknowledged is false, Maintenance is false, Severity is NOT (2 items), and State is not Closed. A user may select a clear condition icon next to a condition to clear it, which would cause that condition to no longer be applied.

Filtering can be by any attribute. One way of filtering is by field. By way of non-limiting example, a field includes a field on the alert itself or a dot-walk field. Dot-walking allows access to fields and field values on related records, even if they are not in the same table. For example, data within a particular table may be filtered by data residing in another table. By way of non-limiting example, fields on a related table may be accessed from a form, list, or script by dot-walking.

In various embodiments, the disclosed techniques improve user experience by reducing the number of clicks and the number of forms opened in order to achieve the same result or present the same information. Useful data for prioritization, impact realization, and root cause analysis may be incorporated.

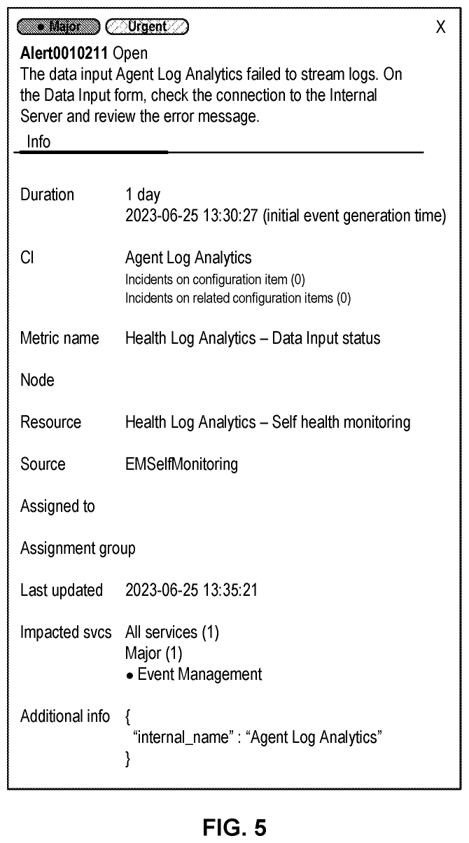

The express list is easy to navigate, intuitive, and familiar because of the way data is presented in the list and how filtering is facilitated by the interactive filter panel. For example, a user may easily sort data by selecting the category name. Referring to the list area 150, alert details may be displayed when a user selects an alert number. In this example, each row corresponds to an alert. The alert in the first row is Alert0294321 (a unique ID), and it has a corresponding description (the entire text may be cut off to display properly in the column or the text may be wrapped), a duration, severity, priority, source, impacted services, and configuration items. Additional and/or a summary of alert information may be displayed in an alert panel (an example of which is shown in FIG. 5) when a user selects the row. In various embodiments, the list is infinitely scrollable such that additional rows/alerts are loaded and displayed while the user scrolls. Cells can contain multiple values. For example, there are three impacted services (ACC Crowdstrike, ACC Docker Engine, and ACC Linux Server) for the first alert.

Alerts may be grouped to reduce clutter in the list. Grouped alerts may contain an icon indicating the number of grouped alerts. For example, Alert294313 includes a group of 11 alerts. A user may drill down to view alerts that are members of this group, e.g., by selecting the arrow next to a grouped alert.

In various embodiments, an express list supports one or more of the following functions:
Filter by alert field(s)
Filter by tag(s)
Filter by impacted service(s)
Filter by configuration item(s)
Perform action(s) on a group of one or more alerts (e.g., close, assignment, acknowledge, put into maintenance, and remediation actions).
Time selection or pause/resume the live list
Add or remove columns
Filter out or show matching alerts, e.g., by right-clicking on the list.
Sort columns
Personalization: the list can be organized according to a user's needs, enabling the user to prioritize issues, reduce the number of clicks, and minimize time spent to find information
Filter via a filter panel: a user may create different views of categorized alerts, creating a targeted list of alerts to prioritize
Preview an alert: view additional alert information by selecting a row and viewing the information in the side panel, which helps a user assess and resolve incidents without the need to open multiple alert forms.

The express list can be personalized as follows. In various embodiments, column widths and orders are fully adjustable. Each column can be sorted by selecting the arrow (\hat{ }) next to the column name. The arrow direction indicates the order and items can be sorted in ascending or descending order. The columns can be edited by selecting button 156. The user may add alert fields, including dot-walking fields (fields from reference tables).

The express list can be filtered using the interactive filter panel as follows. For example, the user can use filtering features to create different views of alerts, and a targeted list of alerts to prioritize and focus on. The user can create pre-defined filters to define the type of alerts the user would like to focus on.

In various embodiments, an express list supports one or more of the following functions:
Adding and removing fields to the filter
Viewing applied filters
Adding and removing tags to the filter
Filtering by attributes (e.g., text, string, number, and date)
Saving, deleting, or making a default filter 104
Filtering out and show matching items

In various embodiments, a set of one or more filters may be recommended for a particular set of data and/or by default. Example filters include: state, priority, configuration item (CI), and impacted services.

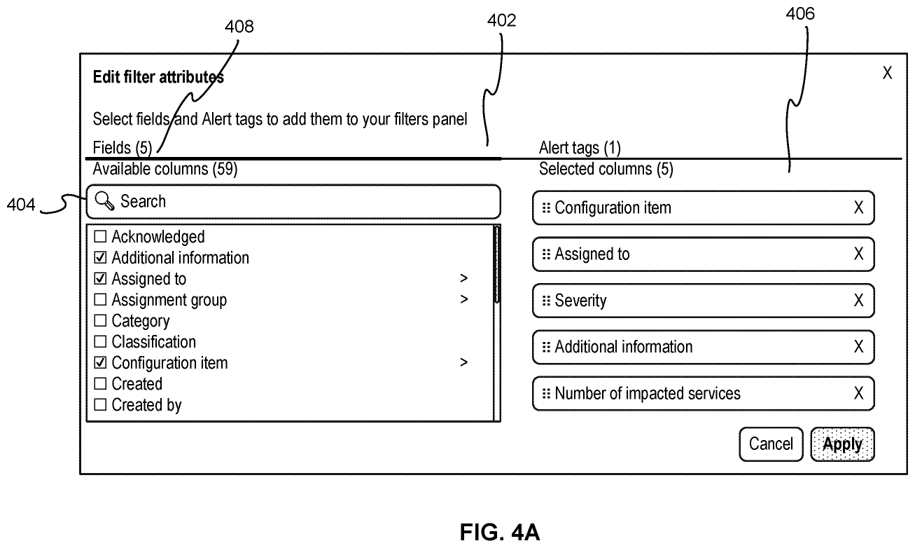

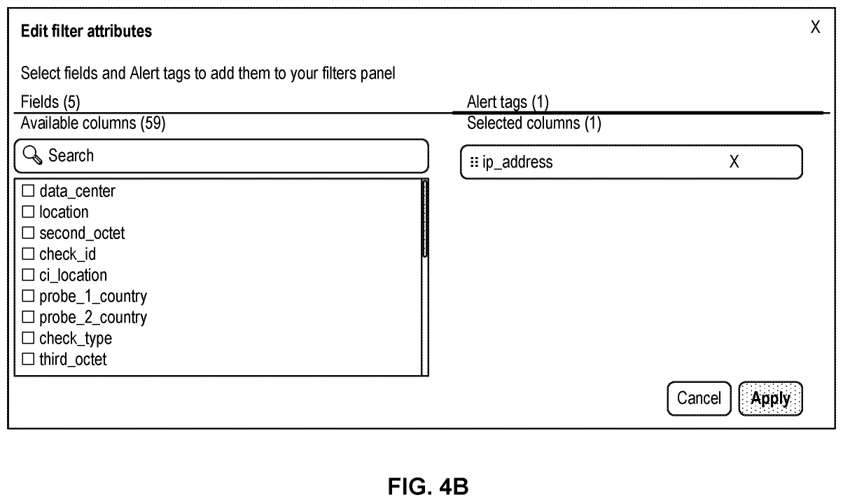

A user may add or remove a filter as follows. The user may select a corresponding button 102 to edit filter attributes. This causes a pop-up screen to be displayed, as further described with respect to FIGS. 4A and 4B.

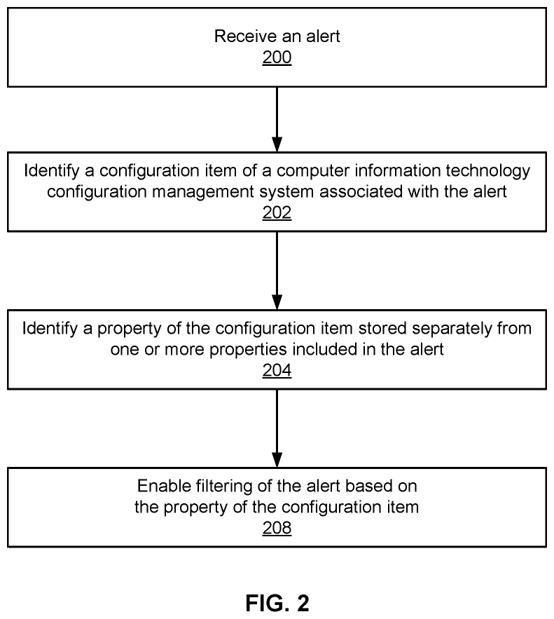

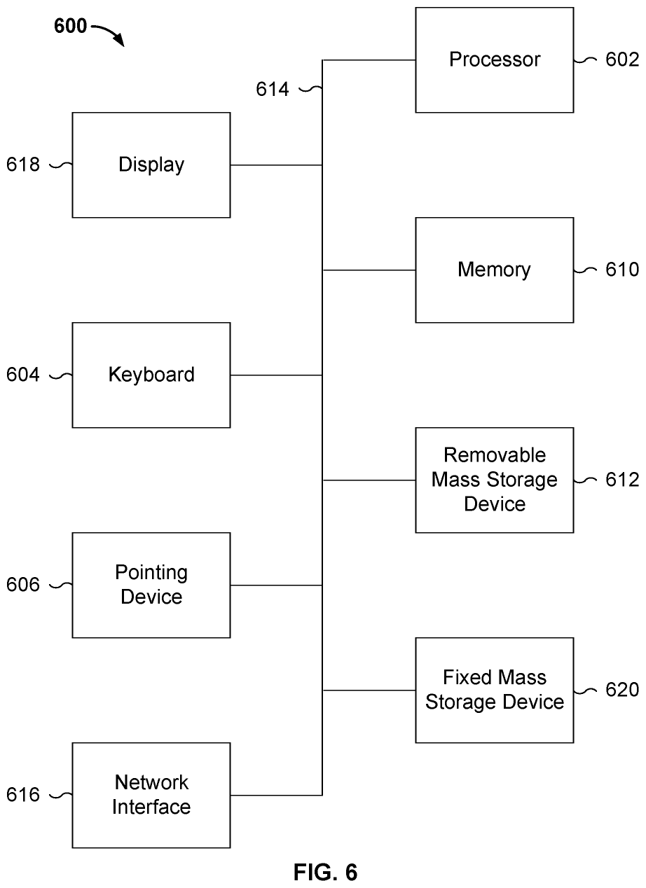

FIG. 2 is a flow diagram illustrating an embodiment of a process for alert filtering based on service to facilitate triage. The process may be implemented by a processor such as 602 of FIG. 6.

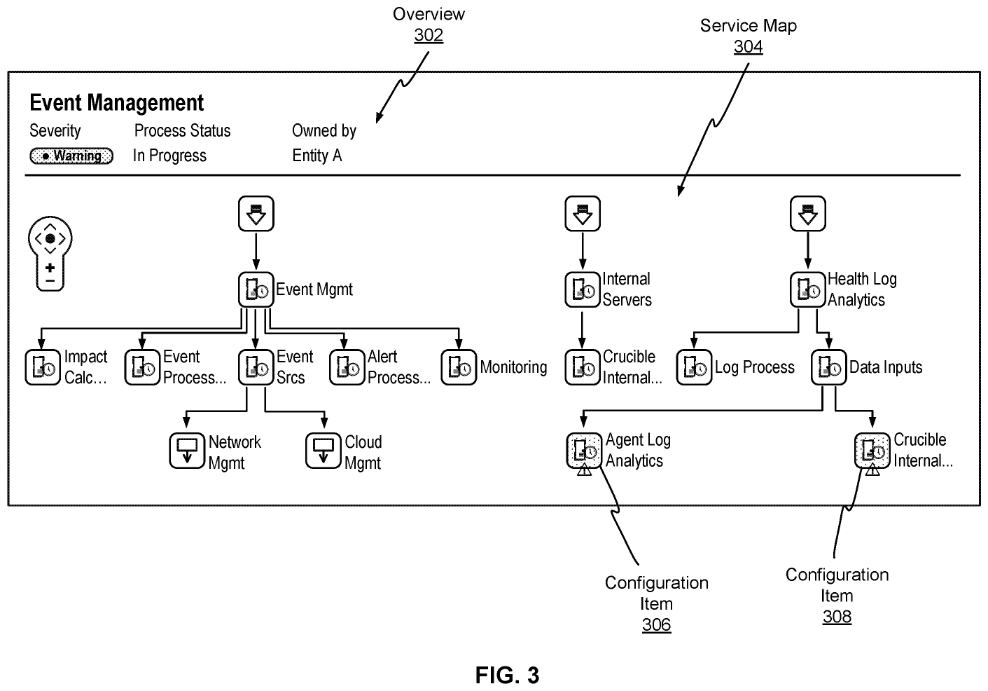

In the example shown, the process begins by receiving an alert (200). An alert is a notification that there is an anomaly or divergence from normal operations. As further described with respect to FIG. 3, an alert may be associated with an application service.

The process identifies a configuration item of a computer information technology configuration management system associated with the alert (202). An alert may affect a configuration item as further described with respect to FIG. 3, and the affected CI(s) may be identified. In various embodiments, identifying the CI associated with the alert includes determining a relationship between the alert and the CI, and determining a relationship between the alert and an application service.

In various embodiments, one or more fields relevant to the alert is identified, and the alert is placed in an appropriate table. The field may be pre-determined or defined by a user/administrator. For example, a field relevant to the alert is a tag, which is further described herein with respect to FIG. 4. A user may define, e.g., via a rule, that a tag should be associated with a particular alert or type of alert. When a new alert is created/received, the process adds a tag to an alert if conditions of the alert meet the rule conditions. By placing the alert in an appropriate table after receiving the alert and prior to searching/filtering, the search experience can be enhanced because there is low latency when the search is performed. When a user wishes to view alerts by filtering criteria (e.g., one or more fields), then alerts matching the criteria are determined by finding the appropriate table. This information is represented on a user interface so that the user does not need to navigate to many/different pages to obtain the desired information.

In various embodiments, 202 is performed on a schedule or when a new alert is processed, the alert is analyzed to determine associated attributes. This may improve user experience because latency is lower compared with conventional search techniques because associations of tags with alerts are performed when an alert is first received rather than when the search is performed.

The process identifies a property of the configuration item stored separately from one or more properties included in the alert (204). Unlike conventional techniques which typically support filtering only by properties included in the alert, the present techniques support filtering of alerts by a property such as impacted service or configuration item. In various embodiments, the property of the CI includes an application service and the filtering of the alert includes filtering by impacted application service. This combines the functionality of alert/event management and modeling (service mapping).

The process enables filtering of the alert based on the property of the configuration item (206). As further described herein, the property or criteria for filtering may include ones that are not typically supported by conventional techniques. In a standard data model, there may be several different tables. In various embodiments, what is displayed in an express list appears to be an alert table, but the underlying data and filtering functionality can actually be across multiple tables. A result associated with the filtering of the alert based on the property of the configuration item may be presented on a GUI.

Using a configuration item as an example, a user can filter by different aspects of the CI. Suppose the user wants to filter by the user or the group that owns the CI. The user can filter to view the alerts that are on a specific database server. The user does not need to specify each and every database server that they own. Instead, the user can view the desired information by filtering by the class of the group, or by the CIs owned. This information is not stored on the alert table, and instead is stored across multiple different tables. For example, a reference to a different table holds this information, and can be used to filter the alerts. This type of filtering is typically not supported by conventional relational databases.

Various calculations may be performed to perform filtering by conditions. For example, relevant data across one or more tables may be extracted. There may be references between alerts, configuration items, services, or the like across tables. The process invokes appropriate APIs to gather the information to provide an indication or prediction of what is affected when filtering by a particular set of criteria.

In various embodiments, the process further includes enabling filtering of the alert based on the one or more properties included in the alert such as a tag (key-value pair). The one or more properties included in the alert includes a key-value pair, and the filtering of the alert is based at least on a value of the key-value pair. The key-value pair includes a single key associated with one or more values, as further described herein.

In various embodiments, the process extracts a topology of connected devices/services (e.g., a service map). The service map is used to determine the impact on a particular application service, because an application service may be implemented by various configuration items. When filtering (by a condition, tag, or the like), supporting tables indicate how an alert impacts the service.

FIG. 3 shows an example of a service map for which alert filtering based on service to facilitate triage may be performed. The service map indicates the relationships between configuration items of a computer information technology configuration management system, and helps to visualize how an application service is implemented. As used herein, an “application service” refers to any functionality or service that can be provided by a computer. For example, a digital service may include an application cloud service. As used herein, a “configuration item” (CI) refers to a computer, device, software, or service that is used to provide the digital service. By way of non-limiting example, a CI is a central processing unit (CPU), graphical processing unit (GPU), disk, storage volume, virtual machine (VM), or load balancer. At least some of the CIs may be provided by a dedicated cloud service provider such as a third-party service provider, where the third-party is an entity different from an application server and a customer/client. Each of the CIs may have associated resource expenditures such as computational or other costs including memory, power, processing cycles, subscription/usage fees, or the like. The third-party service providers may report resource expenditures.

An example of a digital (application) service is a human resources portal that employees can use to find information regarding benefits, log vacation time, or the like. In various embodiments, CIs utilized to provide a digital service are identified using Service Mapping (sometimes referred to as Top-down Discovery) by ServiceNow. In various embodiments, Top-down Discovery includes finding and mapping CIs that are part of application services. For example, Top-down Discovery can map a Website business service by showing the relationships between a particular Web server service, a particular server, and a particular database that stores the data for the business service.

In various embodiments, Top-down discovery is performed using discovery patterns to find CIs belonging to the service and connections between the CIs. A pattern refers to a sequence of commands whose purpose is to detect attributes of a CI and its outbound connections. A pattern used for Discovery may also be used for Service Mapping.

Top-down discovery may use an entry point (e.g., a URL or a combination of an IP address and port) to see where a transaction goes (e.g., URL to load balancer, to application server, to database server) to discover the application service. Service Mapping starts a mapping process from this point. Entry points vary depending on the nature of the application service. Service Mapping comes with a wide range of preconfigured entry point types that cover many commonly used applications. For example, to map an email application service, an entry point may be an IP address or host name of the email server. The process then identifies dependencies between the CIs based on connections between them. The identified CIs can be stored in the CMDB.

In this example, configuration items 306 and 308 have associated alerts. Here, configuration item 306 corresponds to an agent log analytics and configuration item 308 corresponds to a crucible internal server.

Configuration items 306 and 308 are impacting the status of the current service because they have alerts. The determination that the CIs 306 and 308 are behaving abnormally may be based on background jobs. A job may be performed to populate referencing between an alert to a certain CI and/or between an alert to a particular service. A job may be performed on a schedule.

A user may define one or more criterion for filtering, as further described herein. By way of non-limiting example, a user can filter by:
Time period, e.g., alerts from the last 24 hours
Status of alert, e.g., not currently closed or not acknowledged.
Status of a CI associated with the alert, e.g., not in maintenance
Severity

Alerts may be identified to be part of a group or correlated. In various embodiments, alert correlation is performed using correlation logic. Alert correlation enables alerts to be grouped so that noise is reduced by grouping related alerts when displaying them to the user. Correlation logic refers to techniques used to group alerts. For example, correlations may be based on topology, rules, machine learning, or the like.

There are many benefits to performing alert correlation. In one aspect, the user interface/express list may be made less noisy because alerts are grouped. In another aspect, alert correlation is helpful for root cause analysis. For example, a configuration management database (CMDB) correlation or topology based correlation means that the system has identified some topological relationship between different alerts. By identifying and providing to a user a group of alerts in which the alerts within the group have a topological relationship to each other, the user may more easily understand that there is a topological relationship between the alerts. For example, an originating alert has an network/applicative connection with another alert.

Within a group, a specific alert may be called a “parent alert,” and alert filtering may be performed based on one or more parameters of the parent alert. In various embodiments, a group of alerts has a hierarchy including a parent and one or more secondary/children alerts. For example, the alert selected to be the parent made by made according to an alert correlation engine.

The numbering next to the parent alert is an indication of how many alerts are in the group. The number is helpful to indicate to the user the type of result that will be presented. Similarly, each tag can have a number that is a count of the values for the tag (key).

Suppose a user wishes to filter alerts that are assigned to a specific group in order to assign those alerts matching the filter criterion to another group (such as a group that the user owns/manages). The user can use alert filtering based on the parent alert's parameters to view all of the alerts that are assigned to all the groups the user is managing. This is typically not feasible using conventional techniques. The parent alert describes a situation at a higher (larger, more abstract) level than just the individual alert. The parent alert aggregates information from different alerts. Therefore, when a user searches for an alert that happens to be a secondary alert, the user will see a greater context than just the individual alert.

In various embodiments, when a correlation between alerts is identified, an alert group is created. Referring briefly to FIG. 1, Alert0294313, which represents an alert group with 11 members, can be expanded by selecting the row that shows the first alert in an alert group or the arrow next to the parent alert, and associated alerts will be displayed as additional rows beneath the first alert in the group.

FIG. 4A shows an example of a user interface for editing filter attributes. The attributes of a filter may be edited. The disclosed techniques support flexible filtering, allowing the user to filter according to any desired attribute. This user interface may be presented as part of another user interface such as the one shown in FIG. 1 as a pop-up, or may be displayed when selecting a link from FIG. 1.

In various embodiments, the Fields section 402 is displayed by default and displays the number of selected fields/columns (here, five). The GUI includes a section 402 for selecting and searching for fields and a section 406 for manipulating the selected fields/columns. The number of available fields are displayed at the top of the section 402 next to Available columns (here, 59). The selected fields/columns are displayed in section 406. The number of selected fields/columns are displayed. A search box 404 allows a user to search for fields from the available columns. (here, Additional information, Assigned to, and Configuration item are visible). In the right column, each of the selected columns may be dragged up or down to arrange/re-arrange the order.

In various embodiments, alerts may be filtered by impacted (application) services. In the context of alerts, an impacted service is a service that is related to alert, for example a service whose performance has been affected and the alert is a notification of the service being affected. Being able to filter by impacted services means that the user will be able to see alerts that are impacting a particular service. In various embodiments, a user can filter by the number of impacted services. Presenting alerts and impacted services in an express list in this way may be easier to understand for a user. For example, a user does not need to leave the current UI to view the health status of various services. Filtering by impacted services combines an event management functionality with a modeling (service mapping) functionality, which is typically not supported by conventional techniques.

In various embodiments, alerts may be filtered by affected configuration items. Being able to filter by CI is helpful for alert correlation and grouping. An alert group is a combination or aggregation of multiple alerts. An alert may impact or affect a different CI. If a user filters by a specific CI, the user will be able to see the alert itself as well as other related alerts such as other alerts affecting the specific CI.

FIG. 4B shows an example of a user interface for editing filter attributes to add tags to filters. The attributes of a filter may be edited. The disclosed techniques support flexible filtering, allowing the user to filter according to any desired attribute. This user interface may be presented as part of another user interface such as the one shown in FIG. 1 as a pop-up, or may be displayed when selecting a link from FIG. 1.

The elements of FIG. 4B are like their counterparts in FIG. 4A unless otherwise described. Similar to FIG. 4A, the left column displays the number of available tags at the top of the column next to “Available columns.” The selected tags are displayed in the right column. Here, the selected tag is “ip_address.” The number of selected tags are displayed at the top of the column next to “Selected columns.” A user can search for fields using the Search box.

In various embodiments, alerts may be filtered by tag. A tag is a dynamic key-value structure associated with an alert. A tag may be added by a user to an alert, and is beneficial for example because the tag enriches the alert or helps the alert to conform to a standardization between the different monitoring sources. In various embodiments, a tag is not part of a base data model, and is flexible according to the desired implementation. The user can use the tag for filtering purposes.

Conventional techniques do not support filtering by key-value pairs, and at most permit filtering by key or hashtag, but not by value. By contrast, as used herein a “tag” refers to a key-value pair, so each “tag” can have various options/values. Alerts may be filtered by the value of the tag. A tag may be created by an administrator. For example, a key-value pair may be created by mapping data elements (values) to tags (keys). In various embodiments, each alert has a tag with a corresponding value.

Referring briefly to FIG. 1, a section in panel 110 allows a user to filter by alert tags. For example, the alerts may be filtered by a “metric_subject” tag. The “metric_subject” tag can have various values, and user may see the optional values and pick one or more of the values to filter by.

For example, the user may enter a value of the tag in the search box 112. As another example, options for values may be displayed (not shown), e.g., in a drop-down menu. As yet another example, when the user searches for the value of the tag, auto-complete suggestions may be displayed to help the user find a valid value for the tag by which the user wishes to filter alerts. After filtering by tag, only alerts that have a tag component matching the specified value are displayed.

If one of the attributes of an alert is a tag, then the alert and tag (key-value pair) are added to an appropriate table. Subsequently, when a user wishes to filter alerts by tag, the table is queried to find those alerts with matching tags. For example, scheduled jobs are performed in the background to scan alerts and update tables. In various embodiments, the tables may be periodically cleaned up to remove obsolete/stale data or other data that is no longer relevant or has not been used within a time period.

FIG. 5 shows an example of an alert panel. An alert panel includes information associated with a record such as summary, details, or the like. The alert panel can be displayed as a pop-up or alongside an express list such as the one shown in FIG. 1. In various embodiments, the alert panel includes a summary of alerts and at least one insight associated with the alerts. One benefit of the alert panel, is that a user can view alert details without drilling down to the alert, e.g., leaving the current view to load a drill-droll report of the alert. In various embodiments, the alert panel displays insights such as how many incidents are existing on the CI, incidents on related CIs, similar alerts that have been opened recently, or repeated alerts that have been opened recently.

In various embodiments, remediation actions may be performed to one or more alerts. Conventionally, a remediation action could only be performed for one alert at a time. By contrast, the present techniques allow a remediation action to be performed for a group of alerts. In various embodiments, one or more rules are created in a rule engine, and calculations are performed to determine available actions for a particular alert. The available actions are presented via a user interface such as the express list of FIG. 1, and a user can select alerts (e.g., ticking off a box next to each alert) and selecting one or more remediations actions to perform for the group of alerts. One advantage of bulk remediation is reducing the time it takes to make repairs associated with the alerts.

FIG. 6 is a functional diagram illustrating a programmed computer system for executing alert filtering based on service to facilitate triage in accordance with some embodiments. As will be apparent, other computer system architectures and configurations can be used to perform alert filtering. Computer system 600, which includes various subsystems as described below, includes at least one microprocessor subsystem (also referred to as a processor or a central processing unit (CPU)) 602. For example, processor 602 can be implemented by a single-chip processor or by multiple processors. In some embodiments, processor 602 is a general purpose digital processor that controls the operation of the computer system 600. Using instructions retrieved from memory 610, the processor 602 controls the reception and manipulation of input data, and the output and display of data on output devices (e.g., display 618). In some embodiments, processor 602 includes and/or is used to execute/perform the process described with respect to FIG. 2.

Processor 602 is coupled bi-directionally with memory 610, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 602. Also as is well known in the art, primary storage typically includes basic operating instructions, program code, data and objects used by the processor 602 to perform its functions (e.g., programmed instructions). For example, memory 610 can include any suitable computer-readable storage media, described below, depending on whether, for example, data access needs to be bi-directional or uni-directional. For example, processor 602 can also directly and very rapidly retrieve and store frequently needed data in a cache memory (not shown).

A removable mass storage device 612 provides additional data storage capacity for the computer system 600, and is coupled either bi-directionally (read/write) or uni-directionally (read only) to processor 602. For example, storage 612 can also include computer-readable media such as magnetic tape, flash memory, PC-CARDS, portable mass storage devices, holographic storage devices, and other storage devices. A fixed mass storage 620 can also, for example, provide additional data storage capacity. The most common example of mass storage 620 is a hard disk drive. Mass storage 612, 620 generally store additional programming instructions, data, and the like that typically are not in active use by the processor 602. It will be appreciated that the information retained within mass storage 612 and 620 can be incorporated, if needed, in standard fashion as part of memory 610 (e.g., RAM) as virtual memory.

In addition to providing processor 602 access to storage subsystems, bus 614 can also be used to provide access to other subsystems and devices. As shown, these can include a display monitor 618, a network interface 616, a keyboard 604, and a pointing device 606, as well as an auxiliary input/output device interface, a sound card, speakers, and other subsystems as needed. For example, the pointing device 606 can be a mouse, stylus, track ball, or tablet, and is useful for interacting with a graphical user interface.

The network interface 616 allows processor 602 to be coupled to another computer, computer network, or telecommunications network using a network connection as shown. For example, through the network interface 616, the processor 602 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 602 can be used to connect the computer system 600 to an external network and transfer data according to standard protocols. For example, various process embodiments disclosed herein can be executed on processor 602, or can be performed across a network such as the Internet, intranet networks, or local area networks, in conjunction with a remote processor that shares a portion of the processing. Additional mass storage devices (not shown) can also be connected to processor 602 through network interface 616.

An auxiliary I/O device interface (not shown) can be used in conjunction with computer system 600. The auxiliary I/O device interface can include general and customized interfaces that allow the processor 602 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 6 is but an example of a computer system suitable for use with the various embodiments disclosed herein. Other computer systems suitable for such use can include additional or fewer subsystems. In addition, bus 614 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving an alert;
identifying a configuration item of a computer information technology configuration management system associated with the alert;
identifying a property of the configuration item stored separately from one or more properties included in the alert; and
enabling filtering of the alert based on the property of the configuration item.

2. The method of claim 1, wherein identifying the configuration item of the computer information technology configuration management system associated with the alert includes:
determining a relationship between the alert and the configuration item; and
determining a relationship between the alert and an application service.

3. The method of claim 1, wherein the property of the configuration item includes an application service and the filtering of the alert includes filtering by impacted application service.

4. The method of claim 1, further comprising enabling filtering of the alert based on the one or more properties included in the alert.

5. The method of claim 4, wherein the one or more properties included in the alert includes a key-value pair and the filtering of the alert is based at least on a value of the key-value pair.

6. The method of claim 5, wherein the key-value pair includes a single key associated with a plurality of values.

7. The method of claim 1, wherein the filtering of the alert based on the property of the configuration item includes using data stored across a plurality of tables.

8. The method of claim 1, wherein the property of the configuration item includes a dot-walk field that allows access to values on related records stored in different tables.

9. The method of claim 1, further comprising providing via a graphical user interface, a result associated with the filtering of the alert based on the property of the configuration item.

10. The method of claim 9, further comprising providing via the graphical user interface, an alert panel including a summary of alerts and at least one insight associated with the alerts.

11. The method of claim 9, wherein the graphical user interface displays a list of alerts in real-time.

12. The method of claim 11, further comprising enabling a pause in real-time updates to the list of alerts displayed in the graphical user interface.

13. The method of claim 9, wherein the graphical user interface displays a group of alerts identified to be correlated with each other.

14. The method of claim 13, wherein the property of the configuration item includes being a member of the group of alerts.

15. The method of claim 13, further comprising performing a remedial action for the group of alerts.

16. The method of claim 9, wherein the graphical user interface includes an interactive filter panel presenting options to create a view of a list of alerts without leaving the graphical user interface.

17. The method of claim 1, wherein the alert is generated by a monitoring system associated with the computer information technology configuration management system.

18. The method of claim 1, wherein identifying the configuration item of the computer information technology configuration management system associated with the alert includes is performed in response to receiving the alert or according to a pre-determined schedule.

19. A system, comprising:
a processor configured to:
receive an alert;
identify a configuration item of a computer information technology configuration management system associated with the alert;
identify a property of the configuration item stored separately from one or more properties included in the alert; and
enable filtering of the alert based on the property of the configuration item; and
a memory coupled to the processor and configured to provide the processor with instructions.

20. A computer program product embodied in a non-transitory computer readable medium and comprising computer instructions for:
receiving an alert;
identifying a configuration item of a computer information technology configuration management system associated with the alert;
identifying a property of the configuration item stored separately from one or more properties included in the alert; and
enabling filtering of the alert based on the property of the configuration item.
